(19) United States
(12) Patent Application Publication
(10) Pub. No.: US 2019/0202178 A1
(43) Pub. Date: Jul. 4, 2019

(54) A METHOD TO COAT A BUILDING PANEL AND SUCH A COATED BUILDING PANEL

(71) Applicant: Välinge Innovation AB, Viken (SE)

(72) Inventor: Göran Ziegler, Viken (SE)

(73) Assignee: Välinge Innovation AB, Viken (SE)

(21) Appl. No.: 16/325,543

(22) PCT Filed: Aug. 18, 2017
(86) PCT No.: PCT/SE2017/050834

§ 371 Date: Feb. 14, 2019

(30) Foreign Application Priority Data
Aug. 18, 2016 (SE) 1651110-7

(51) Int. Cl. B32B 21/14; B32B 21/13; B32B 21/02; B32B 37/10; B32B 38/00; B32B 37/20

(52) U.S. Cl. CPC B32B 21/14; E04F 15/04; B32B 21/02; B32B 37/10; B32B 38/0036; B32B 38/0008; B32B 37/20; B32B 2250/02; B32B 2255/08; B32B 2255/26; B32B 2255/28; B32B 2260/026; B32B 2260/046; B32B 2262/067; B32B 2305/72; B32B 2307/554; B32B 2310/0831; B32B 2317/16; B32B 2607/00; B32B 21/13

(57) ABSTRACT

A method to at least partially coat a building panel, including applying a first coating composition on a building panel having a surface including at least portions including amino resins, for forming a first coating on at least said portions of said surface, wherein the first coating composition has a glass transition temperature less than 30° C. and reactive portions, applying a second coating composition on at least portions of the first coating for forming a second coating, wherein the second coating composition includes reactive portions adapted to react with the reactive portions of the first coating. The disclosure also relates to such a coated building panel.

### FIELD OF THE INVENTION

The present invention relates to a method to at least partially coat a building panel having a surface comprising at least portions including an amino resin, and such a coated building panel.

### TECHNICAL BACKGROUND

It is known that surfaces including amino resins, such as melamine formaldehyde resins, are difficult to lacquer, for example, with radiation curing lacquers. It is difficult to achieve the desired adherence between the surface including the amino resin and the lacquer layer.

It is also known that surfaces containing amino resins such as melamine surfaces are difficult to glue. Special glues exist and they typically rely on special chemistries that can be grouped as chemically reactive glues. Examples of reactive glues are cyanoacrylate (super glue), silicone glues, acrylic glues (Roo Glue™) urethane glues (Gorilla Glue™) and epoxy glues. In epoxy resins, for example, the high polarity from chemical groups such as the pendant hydroxyl groups of epoxy resins provide adherence to oxide and hydroxyl surfaces such those present on melamine surfaces. After application of the glue in pre-polymer form (where the pre-polymer/oligomer has a low glass transition temperature (T_{g})), a polymerization reaction is allowed to take place resulting in a polymer and a glue bond that is no longer tacky and with improved mechanical properties due to the oligomer being polymerized to a polymer (characterized by, for example, a higher molecular weight and thus with an increase in T_{g}). Such a cured glue bond might be possible to lacquer with a radiation curable lacquer system, but forms an inter coat adherence with limited strength.

In laminate flooring, wherein the floor panel comprises a décor paper impregnated with an amino resin such as melamine formaldehyde resin, a protective layer is conventionally not applied as a lacquer but as an overlay being a resin impregnated paper, preferably including wear resistant particles such as aluminium oxide.

Wood flooring, such as parquet and engineered wood, are usually provided with a protective layer in form of several lacquer layers. The lacquer is conventionally a radiation curable lacquer such as a UV curable lacquer.

New types of flooring such as veneer parquet floorings have been developed during the past years, such as described in WO2015/105455, wherein a wood veneer is arranged on a sub-layer, and during pressing, the sub-layer extends into the wood veneer and fills cracks and holes of the wood veneer. When the sub-layer comprises amino resins such as melamine formaldehyde, lacquering the wood veneer has proven to be difficult due to poor adherence to portions present in the wood veneer layer comprising amino resins.

If a high gloss finish is desired on a floor panel of the type described in WO2009/065769, wherein the surface layer of the floor panel comprising a mix of a binder, wood fibres and wear resistant particles, a coating such as lacquer may be applied. Especially if the binder is an amino resin such as melamine formaldehyde resin, it has proven to be difficult to lacquer such a surface with a final result that is both visually and technically acceptable. Especially flooring applications are very demanding, requiring both excellent adherence to the substrate and intercoat reactivity. However, such high requirements and specified mechanical properties may not be fulfilled by using traditional coating systems.

High gloss coatings on laminates may be using, for example, a hot coating technique, where resins are heated before application. Such a coating requires special equipment and the choice of additional layers and/or top layers in the coating systems is restricted. It would be advantageous to provide a primer system that can provide both good adherence to the substrate and that can be overcoated with a wide selection of coatings, allowing a choice of both visual and mechanical properties such as different gloss levels, not only high gloss, or different scratch resistances.

WO2015/106771, with corresponding publication US2016/0326744, discloses a building board including a core layer and an amino resin impregnated paper. An adhesion layer is applied on the resin impregnated paper to provide adhesion between the resin impregnated paper and an acrylate layer. The adhesion layer comprises a mixture of isocyanate and (meth)acrylate. The (meth)acrylate component is generally preferred a mono-functional alkyl(meth)acrylate that comprises a glassing temperature of not more than 0° C. The adhesion layer is gelled by means of UV radiation. Thereafter, another (meth)acrylate layer is applied on the adhesion layer.

US 2015/0118456 discloses an object with a coating comprising a) covalent bonds formed by reaction of a thiol group and a carbon-carbon double bond, b) covalent bonds formed by reaction of a thiol group and epoxide group, c) covalent bonds formed by a reaction of a carbon-carbon double bond and an epoxide group. The surface of the object to be coated may comprise a metal, a rubber, silicon, a thermoplastic elastomer, cellulose fibres, a textile, wood, a composite material, concrete, and stone.

### SUMMARY

It is an object of at least embodiments of the present invention to provide an improvement over the above described techniques and known art.

A further object of at least embodiments of the present invention is to facilitate coating of a building panel including portions comprising an amino resin.

A further object of at least embodiments of the present invention is to improve adherence of coatings to a surface of a building panel comprising an amino resin.

A further object of at least embodiments of the present invention is to provide any desired gloss grade on a surface of a building panel comprising an amino resin.

At least some of these and other objects and advantages that will be apparent from the description have been achieved by a method to at least partially coat a building panel according to a first aspect of the invention. The method comprises

applying a first coating composition on a surface of a building panel comprising at least portions including an amino resin, for forming a first coating on at least said portions of said surface,

wherein the first coating composition has a glass transition temperature (T_{g}) less than 30° C. and reactive portions,

applying a second coating composition on at least portions of the first coating, wherein the second coating composition comprises reactive portions configured to react with the reactive portions of the first coating.

In one embodiment of the first aspect, the method comprises comprising applying a sub-layer comprising an amino resin on a substrate, applying a wood veneer layer on the sub-layer, pressing the wood veneer layer and the sub-layer such that the amino resin from the sub-layer permeates through the wood veneer layer and after pressing is present at at least portions of a surface of the wood veneer layer facing away from the substrate, subsequently applying a first coating composition on the surface of the wood veneer layer comprising said portions including the amino resin, for forming a first coating on at least said portions of said surface, wherein the first coating composition comprises oligomers having a glass transition temperature (T_{g}) less than 30° C. and reactive portions, heat curing the first coating composition such that the first coating composition is at least partially cured and a first coating is formed, subsequently applying a second coating composition on at least portions of the at least partially cured first coating for forming a second coating, wherein the second coating composition comprises reactive portions configured to react with the reactive portions of the first coating composition.

By applying the first coating composition in pre-polymer form, i.e. as oligomers and having a glass transition temperature (T_{g})<30° C., the first coating composition may have a suitable viscosity to be applied using standard machinery, with no need of special equipment, such as heating, and no need for solvent or water demanding solvent recovery or drying. Furthermore, by applying the first coating composition in pre-polymer form, desirable wetting and adherence to the surface are obtained.

Thereby, the first coating functions as a primer and provide adherence to the building panel for the second coating. Consequently, it is possible to provide adherence to surfaces conventionally known to be difficult to lacquer, such that surfaces comprising amino resins. Thus, problems associated with lacquering surfaces comprising amino resins are overcome or at least reduced. The method also provides the possibility to obtain any desired gloss level, a low gloss level as well as a high gloss level, as the coatings may have any desired gloss level may be applied as second coating and/or further coating layers.

The first coating has two functions; to provide adherence to the surface of the building panel comprising the amino resin, and to provide reactivity to react with the second coating applied on the first coating. The first coating may be regarded as a primer for the second coating.

For a wood veneer surface comprising sub-layer, wherein an amino resin from a sub-layer has permeated through the wood veneer layer during pressing, the first coating provides physical adherence to the wood veneer layer, and provides chemical adherence to the amino resin. For a building panel having a surface layer formed by a mix of an amino resin and fillers, the first coating provides chemical adherence to the amino resin in the surface of the building panel. For a laminate building panel, the first coating provides chemical adherence to the amino resin in the surface of the building panel.

Since the first coating composition is in pre-polymer form, i.e. oligomers, it has a low glass transition temperature (T_{g}) and consequently a low minimum film forming temperature (MFT) and a low viscosity. Thus, the first coating composition is adapted both to be able to coat when using standard coating machinery, such as roller coaters, and in standard application temperatures with no need for special equipment.

Since the first coating composition further comprises reactive portions, the first coating can react with reactive portions of the second coating such that adherence between the first and second coating is provided.

The first coating may function as a barrier layer preventing humidity from reaching the surface layer and the substrate. Thereby, improved climate stability and climate properties can be obtained.

When the first coating composition is applied on the surface of the building panel, the amino resin of the building panel is preferably in C-stage. By C-stage is meant the thermosetting binder is highly crosslinked and both infusible insoluble. (Principles of Polymerization, George Odian, 3^{rd} edition).

The reactive portions of the first and second coating composition may form a covalent bond. The covalent bonding between the first and second coating provides adherence between the first and second coating.

The first coating composition may be at least partially cured prior to applying the second coating composition. By at least partially cured is meant that the binder of the first coating composition is crosslinked to at least 50% of maximum crosslinking, preferably at least 60%, more preferably at least 70% of maximum crosslinking. The first coating composition is preferably cured to a condition wherein the first coating composition do not mix with the second coating composition when applied on the first coating composition. Preferably, the first coating composition is cured to a condition wherein the first composition is no longer tacky.

The first coating composition may be heat activated such that it is at least partially cured by heating. The first composition may be heated to a temperature of 80-130° C., preferably 80-100° C. such as 85-90° C.

The first coating composition may comprise oligomers with chemical groups that can provide good adherence to surfaces comprising amino resins, especially melamine formaldehyde resin, such as polar hydroxyls, amines, amides and carboxylics that can be found in urethane, epoxy, silane, cyanoacrylate and/or acrylate oligomers.

The first coating composition may have a viscosity less than 10 000 mPas, preferably less than 5000 mPas. A viscosity less than 10 000 mPas makes the first coating suitable for application by roller coating. A viscosity less than 5000 mPas makes the first coating suitable for application by roller coating, curtain coating, spraying, etc.

The first coating composition may have viscosity in the range of 1000-5000 mPas, preferably in the range of 1000-4000 mPas.

The second coating composition may be radiation curable and/or heat curable. The second coating composition may be UV curable.

The reactive portions of the first coating composition may be heat activated. Additionally, or as an alternative in embodiments, the chemical reaction of the reactive portions may be radiation activated.

The reactive portions of the second coating composition may be radical polymerizable. The chemical reaction of the reactive portions may be radiation and/or heat activated.

Portions of surface may comprise wood. The surface may comprise a wood veneer layer arranged on a sub-layer comprising an amino resin. The wood veneer layer is preferably pressed to the sub-layer prior to applying the first coating. During pressing, the amino resin from the sub-layer may permeate, partly or completely, the wood veneer layer to the surface of the building panel.

Portions of the surface may be formed of a wood veneer layer, for example, arranged on a sub-layer comprising an amino resin.

Portions of the surface may be formed by a mesh structure. The mesh structure may be arranged on a sub-layer comprising an amino resin. The mesh structure may be formed of a textile material. The textile material may be a non-woven or a woven structure. The textile material may be cloth, fabric, etc. The mesh structure may be formed of a metal material. The mesh structure may be an expanded metal.

The surface may comprise a mix comprising an amino resin and fibres, preferably cellulose and/or wood fibres. The mix is preferably pressed for forming a surface layer prior to applying the first coating.

The first coating and/or the second coating may be transparent.

The first coating and/or the second coating may comprise pigments and/or stains. Thereby, the first and/or second coating may partly or completely stain or colour the surface of the building panel.

The method may further comprise heating and/or radiation curing the first coating prior to applying the second coating composition.

The method may further comprise applying one or several further coating compositions on the second coating. The second coating may form a primer for additional coating compositions, for example forming one or several lacquer layers.

In one embodiment of the first aspect, the method comprising applying a substantially homogenous mix comprising an amino resin and fillers on a substrate, pressing the mix to a surface layer comprising the amino resin and the fillers, subsequently applying a first coating composition on a surface of the surface layer facing away from the substrate, for forming a first coating on said surface, wherein the first coating composition comprises oligomers having a glass transition temperature (Tg) less than 30° C. and reactive portions, heat curing the first coating composition such that the first coating composition is at least partially cured and a first coating is formed, subsequently applying a second coating composition on at least portions of the at least partially cured first coating for forming a second coating, wherein the second coating composition comprises reactive portions configured to react with the reactive portions of the first coating composition.

According to a second aspect of the present invention, a coated building panel is provided. The coated building panel has a surface comprising at least portions including an amino resin, a first coating adhered to at least said portions of said surface, a second coating chemically bonded to the first coating, and optionally one or several further coatings on the second coating, wherein adherence between said surface and the coatings is exceeding 3 MPa, preferably exceeding 3.2 MPa, more preferably exceeding 3.3 MPa, as measured in accordance with ISO 4624:2016.

ISO 4624:2016 is standard test method for a pull-off test for adhesion.

An alternative method for measuring adherence is by using a Hamberger Hobel is device provided by Hamberger (https://www.haro.com/portal/verlegecenter/media/files/Bedienungsanleitung_fue r_den_Hamperer_Hobel.pdf). The Hamberger Hobel, sometimes named coin test, is a recognized test method in flooring technology for testing deep scratch resistance, and thereby also adhesion. Preferably, the adherence between said surface and the coatings is exceeding 20 N, preferably exceeding 22 N, as measured with a Hamberger Hobel.

In one embodiment of the second aspect, the a coated building panel comprises a substrate, a sub-layer arranged on the substrate, and a wood veneer layer, wherein the wood veneer layer has a surface facing away from the substrate comprising at least portions including an amino resin, a first coating adhered to at least said portions of said surface including the amino resin, a second coating chemically bonded to the first coating, and optionally one or several further coatings arranged on the second coating, wherein adherence between said surface and the first and second coating is exceeding 3 MPa, preferably exceeding 3.2 MPa, as measured in accordance with ISO 4624:2016.

Embodiments of the second aspect of the present invention incorporates all the advantages of the first aspect of the invention, which previously has been discussed, whereby the previous discussion is applicable also for the coated building panel.

The first coating may comprise chemical groups comprising polar hydroxyls, amines, amides and carboxylics, epoxy, silane, cyanoacrylate and/or acrylate oligomers.

The second coating may be bonded to the first coating by radical polymerization, preferably by covalent bonds.

The first coating may have a glass transition temperature (T_{g}) exceeding 30° C. In the produced coated product, the first coating has polymerized.

The second coating may comprise acrylate or methacrylate polymer.

The second coating may be radiation cured. The second coating may be UV cured.

Portions of said surface may comprise wood. The surface may comprise a wood veneer layer pressed to on a sub-layer comprising an amino resin. During pressing, the amino resin from the sub-layer may permeate, partly or completely, the wood veneer layer to an upper portion of the wood veneer layer.

Portions of the surface may be formed of wood veneer layer, for example, arranged on a sub-layer comprising an amino resin.

The surface may comprise a mix comprising an amino resin and fibres, preferably wood fibres. The mix is pressed for forming a surface layer prior to applying the first coating.

The surface may comprise a sheet impregnated with an amino resin.

In an embodiment of the second aspect, the coated building panel comprises a substrate and a surface layer comprising an amino resin and fillers, a first coating adhered to a surface of the surface layer facing away from the substrate, a second coating chemically bonded to the first coating, and optionally one or several further coatings arranged on the second coating, wherein adherence between said surface and the first and second coating is exceeding 3 MPa, preferably exceeding 3.2 MPa, as measured in accordance with ISO 4624:2016.

A third aspect of the invention is use of a first coating composition for forming a first coating on a surface of a building panel comprising at least portions including amino resins, wherein the first coating composition comprises oligomers having a glass transition temperature (T_{g}) less than 30° C. and reactive portions.

The first coating composition may comprise oligomers with chemical groups that can provide good adherence to surfaces comprising amino resins, especially melamine formaldehyde resin, such as polar hydroxyls, amines, amides and carboxylics that can be found in urethane, epoxy, silane, cyanoacrylate and/or acrylate oligomers.

The reactive portions may be configured to react with the reactive portions of a second coating.

The first coating composition may form a primer for a second coating composition.

Portions of the surface may be formed of wood. For example, a wood veneer layer may be arranged on a sub-layer comprising an amino resin, where material from the sub-layer such as amino resin has permeated through the wood veneer layer during pressing. Material from the sub-layer such as amino resins are present at the surface of the building panel.

The surface may comprise a mix comprising an amino resin and fibres, preferably wood or cellulose fibres, and optionally wear resistant particles. The mix is pressed for forming a surface layer prior to applying the first coating.

The surface may comprise a sheet impregnated with an amino resin.

Embodiments of the third aspect of the present invention incorporates all the advantages of the first aspect of the invention, which previously has been discussed, whereby the previous discussion is applicable also for the first coating composition.

### BRIEF DESCRIPTION OF THE DRAWINGS

The present invention will by way of example be described in more detail with reference to the appended schematic drawings, which show embodiments of the present invention.

FIG. 1 shows a method of coating a building panel.

FIG. 2 shows an embodiment of such a coated building panel.

FIG. 3 shows a method of coating a building panel.

FIG. 4 shows an embodiment of such a coated building panel.

FIG. 5 shows an embodiment of a coated building panel.

### DETAILED DESCRIPTION

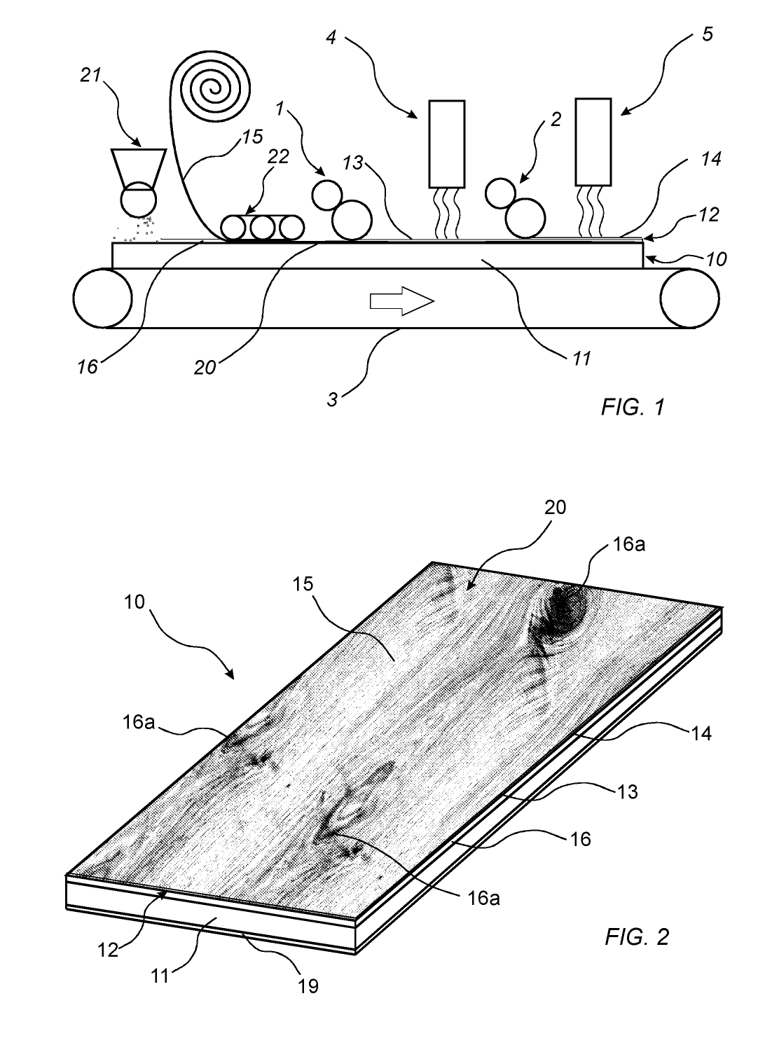

A method of coating a building panel 10 will now be described with reference to FIG. 1. In FIG. 1 a production line including a coating line is shown. The coating line comprises a first coating device 1 and a second coating device 2. In FIG. 1, both the first and the second coating devices 1, 2 are roller coaters, but any other type of coating device is contemplated, such as curtain coating, spraying, dip coating, etc.

A building panel 10 is conveyed by a conveyor 3 through the first coating device 1 and subsequently to the second coating device 2. The building panel 10 comprises a surface layer 12 having a surface 20 to be coated, facing away from the surface facing the conveyor.

The building panel 10 may be a furniture component, a floor panel, a ceiling panel, a wall panel, a door panel, a worktop, skirting boards, mouldings, edging profiles, etc.

The surface 20 of the building panel 10 comprises at least portions including an amino resin. The amino resin may be present in only parts of the surface or in the complete surface. The amino resin may be melamine formaldehyde resin, urea formaldehyde resins, or combinations thereof.

In one embodiment shown in FIG. 1, the surface layer 12 and the surface 20 thereof comprises a wood veneer layer pressed to a sub-layer comprising an amino resin. The surface layer 12 is formed by applying a sub-layer 16 on a substrate 11. The substrate 11 may be pre-fabricated substrate, manufactured prior to coating the surface of the building panel 10. The substrate 11 may be a board, for example, a wood-based board. The wood-based board may be a wood fibre based board such as MDF, HDF, particleboard, or a plywood board. In other embodiments, the substrate 11 may be a Wood Plastic Composite (WPC). The substrate 11 may be a mineral composite board. The substrate 11 may be a fibre cement board. The substrate 11 may be magnesium oxide cement board. The substrate 11 may be a ceramic board. The substrate 11 may be a plastic board such as a thermoplastic board. In another embodiment, the substrate 11 may be a carrier such as sheet of paper or non-woven, or a conveyor. The substrate 11 may be a thermoplastic foil, such as a polyurethane (PU) or polyvinyl chloride (PVC) foil. The sub-layer 16 comprises an amino resin, such as melamine formaldehyde resin, urea formaldehyde resins, or combinations thereof, and optionally fillers and additives. The fillers may be fibres such as cellulose fibres. The fibres may be wood fibres and/or wood particles. The sub-layer 16 may further comprise pigments. The sub-layer is applied as a mix, preferably in dry powder form, on the substrate 11 by a scattering device 21 in the embodiment shown in FIG. 1. A wood veneer layer 15 is thereafter arranged on the sub-layer 16.

The wood veneer layer 15 and the sub-layer 16 is thereafter pressed together in a press 22. The press may be static or a continuous press. During pressing, material from the sub-layer 16 such as the amino resin of the sub-layer 16 permeates through the wood veneer layer 15, as described in WO 2015/105455 and WO2015/105456, which are incorporated by reference, such that at least material 16a, including the amino resin, from the sub-layer 16 is present at the surface 20 of the building panel 10. Thereby, after pressing, material 16a from the sub-layer 16 including the amino resin is present at the surface 20 of the building panel 10. The amino resin may be present at the surface 20 of the building panel 10 in pores in the wood veneer layer 15, in holes in the wood veneer layer 15, and/or in cracks in the wood veneer layer 15. After pressing, the sub-layer 16 fills holes, cracks and pores of the wood veneer layer 15. After pressing, the surface 20 of the building panel may comprise portions formed of wood only, portions formed of material including the amino resin from the sub-layer 16 only, and portions comprising both wood and material from the sub-layer 16 such as the amino resin of the sub-layer 16.

After pressing, the amino resin is preferably substantially in C-stage prior to coating. By C-stage is meant the thermosetting binder is highly crosslinked and both infusible insoluble. (Principles of Polymerization, George Odian, 3^{rd} edition).

After pressing but prior to applying the first coating composition, the surface 20 of the building panel 10 may be sanded. If the surface 20 of the building panel 10 comprises wood portions as in the embodiment described with reference to FIG. 1, the surface 20 is preferably sanded prior to applying the first coating.

As shown in FIG. 1, the building panel 10 is conveyed to the first coating device 1. The first coating device 1 applies a first coating composition on the surface 20 of the building panel 10 including at least portions comprising the amino resin. The first coating composition applied on the surface 20 of the building panel 10 forms a first coating 13. The first coating composition may be applied on at least said portions of the surface 20 of the building panel 10. Preferably, the first coating composition is applied on substantially the complete surface 20 of the building panel.

The first coating composition comprises oligomers having a T_{g}<30° C. Further, the first coating composition comprises reactive portions configured to be reactive with reactive portions of a second coating. The first coating composition is configured to provide adherence to the surface 20 of the building panel 10, and more specifically provide adherence to the portions of the surface 20 of the building panel 10 including the amino resin. Due to the low glass transition temperature of the oligomers, the first coating composition is sticky such that the first coating adheres to the surface 20 of the building panel 10. The adherence to the surface 20 of the building panel 10 may be formed by different properties of the first coating 13. For example, the first coating 13 may be physically adhered to portions of the surface 20 of the building panel 10 formed of wood. To portions of the surface 20 of the building panel 10 comprising the amino resin, the first coating 13 may be chemically adhered to such portions.

The first coating composition may comprise oligomers with chemical groups that can provide good adherence to surfaces comprising amino resin, especially melamine formaldehyde resin, such as polar hydroxyls, amines, amides and carboxylics that can be found in urethane, epoxy, silane, cyanoacrylate and/or acrylate oligomers. The first coating composition may comprise chemical groups that can be further reacted with a radical chain polymerization such as a UV coating. Such groups can be acrylic, methacrylic, allylic and/or carbon-bonded sulfhydryl groups.

The first coating composition may have a viscosity of less than 10 000 mPas, preferably less than 5000 mPas. For example, the first coating composition may have viscosity in the range of 1000-5000 mPas, preferably in the range of 1000-4000 mPas. Viscosity in such ranges provides desired coating and application properties of the first coating composition.

The first coating composition may be applied in amount of 5-15 g/m². The first coating 13 may be transparent, or at least transparent after drying and/or curing. The first coating 13 may comprise pigments and/or stain, in order to at least partly colour the surface 20 of the building panel 10 if desired.

Prior to applying a second coating composition on the first coating 13, the first coating composition is heated to be at least partially cured by applying IR, NIR, hot air, etc., in a first heating device 4 to form a first coating 13. The first coating 13 is at least partially cured to a state wherein the first coating 13 is no longer tacky. The first coating 13 is at least partially cured to a state there a second coating 14 subsequently applied will not be mixed into the first coating 13. The first coating 13 may also be radiation cured such as by electron beam (EB) and/or UV curing.

The first coating 13 may be a primer for the second coating 14 subsequently applied.

A second coating composition is applied on the first coating 13 for forming a second coating 14. The second coating composition is applied on at least a portion of the first coating 13. Preferably, the second coating composition is applied on substantially the complete first coating 13, such that the second coating 14 covers the first coating 13.

The second coating composition may have a viscosity of less than 10 000 mPas, preferably less than 5000 mPas. For example, the second coating composition may have viscosity in the range of 1000-5000 mPas, preferably in the range of 1000-4000 mPas. Viscosity in such ranges provides desired coating and application properties of the second coating composition.

The second coating composition may be applied in amount of 5-50 g/m². The second coating 14 may be transparent, or at least transparent after drying and/or curing. The second coating 14 may be pigmented and/or stained.

The second coating 14 may form a primer for additional coating layers (not shown), or may form a top coating such as lacquer layer (not shown) having any desired gloss level.

The second coating composition comprises reactive portions configured to react with the reactive portions of the first coating 13. Thereby, a chemical bonding between the first and second coating 13, 14 may be obtained. The reactive portions of the first and second composition may form a covalent bond. The second coating composition may comprise chemical groups that can be further reacted with a radical chain polymerization such as a UV coating. Such groups can typically be acrylic and methacrylic. The second coating composition may comprise photoinitiators. The second coating composition may be radical polymerizable, for example radiation activated. The second coating composition may be radiation curable such as UV curable.

The second coating composition may comprise an acrylate or methacrylate monomer, or an acrylate or methacrylate oligomer. The acrylate or methacrylate monomer or oligomer may be an epoxy (meth)acrylate, a urethane (meth)acrylate, a polyester (meth)acrylate, a polyether (meth)acrylate, an acrylic (meth)acrylate, a silicone (meth)acrylate, a melamine (meth)acrylate, or combinations thereof.

After applying the second coating composition such that the second coating 14 is formed, the second coating 14 may be heated and/or at least partially cured, for example by radiation such as electron beam (EB) and/or UV curing, or by applying heat such as by applying IR, NIR, hot air, etc., in a second heating or radiation device 5.

Subsequent to applying the second coating composition, one or several additional coating compositions may be applied on the second coating for forming additional coatings (not shown). Such additional coatings may be different lacquer layers.

Thereby, a coated building panel 10 is formed.

In FIG. 2, the coated building panel 10, produced by the method described above with reference to FIG. 1, is shown in more detail. The coated building panel 10 may be any type of building panel 10 such as among other a furniture component, a floor panel, a ceiling panel, a wall panel, a door panel, a worktop, skirting boards, mouldings, edging profiles, etc. The coated building panel 10 in FIG. 2 comprises a substrate 11, a surface layer 12 and a balancing layer 19. The substrate 11 may be pre-fabricated, manufactured prior to coating the surface 20 of the building panel 10. The substrate 11 may be a board, for example, a wood-based board. The wood-based board may be a wood fibre based board such as MDF, HDF, particleboard, or a plywood board. In other embodiments, the substrate 11 may be a Wood Plastic Composite (WPC). The substrate 11 may be a mineral composite board. The substrate 11 may be a fibre cement board. The substrate 11 may be magnesium oxide cement board. The substrate 11 may be a ceramic board. The substrate 11 may be a plastic board such as a thermoplastic board. In another embodiment, the substrate 11 may be a carrier such as sheet of paper or non-woven, or a conveyor. The substrate 11 may be a thermoplastic foil, such as a polyurethane (PU) or polyvinyl chloride (PVC) foil.

In the shown embodiment, a balancing layer 19 is arranged on a surface of the substrate 11 opposite to the surface layer 12. The balancing layer 19 may be a powder based balancing layer being applied as a powder. The powder based balancing layer may comprise wood particles such as lignocellulosic and/or cellulosic particles and a binder, preferably a thermosetting binder such as an amino resin. The balancing layer 19 may be a resin impregnated paper, preferably impregnated with a thermosetting binder.

In the embodiment shown in FIG. 2, the surface layer 12, and thereby the surface 20 of the building panel 10, comprises a wood veneer layer 15 arranged on a sub-layer 16. The sub-layer 16 comprises an amino resin, such as melamine formaldehyde resin, urea formaldehyde resins, or combinations thereof, and optionally fillers and additives. The wood veneer layer 15 and the sub-layer 16 have been pressed together prior to coating. During pressing, material from the sub-layer 16 including the amino resin permeates through the wood veneer layer 15 such that at least material 16a from the sub-layer 16 is present at the surface 20 of the building panel 10. Thereby, after pressing, material 16a from the sub-layer 16 including the amino resin is present at the surface 20 of the building panel 10. The amino resin may be present at the surface 20 of the building panel 10 in pores in the wood veneer layer 15, in holes in the wood veneer layer 15, and/or in cracks in the wood veneer layer 15.

A first coating 13 of the type described above with reference to FIG. 1 is arranged on the surface 20 of the building panel 10. The first coating 13 is preferably arranged on both portions of the surface 20 comprising wood veneer layer 15, on portions 16a of the surface 20 formed of amino resin, and/or on portions of the surface 20 formed by wood veneer layer 15 with amino resin in the pores. The first coating 13 provides adherence to both the wood veneer layer 15 and the portions 16a of the surface 20 comprising amino resin.

A second coating 14 of the type described above with reference to FIG. 1 is arranged on the first coating 13. The second coating 14 is chemically bonded to the first coating 13.

The first coating 13 may form a primer for the second coating 14.

In the final product, it may be difficult to see any border between the first coating 13 and the second coating 14. There may be a zone between the first and second coating 13, 14 wherein the first and second coating 13,14 are fused together.

In one embodiment, the second coating 14 forms a primer for one or several additional coatings (not shown) applied on the second coating 14. Said one or several additional coatings may be different types of lacquer layers having a desired gloss level. In one embodiment, the second coating forms a top lacquer layer.

The second coating 14 and/or additional coatings applied on the second coating may be lacquers. A lacquered wood veneer building panel 10 having portions 16a comprising the amino resin at the surface 20 of the building panel 10 is provided. The lacquered wood veneer building panel 10 may have any desired gloss level. For example, a low gloss surface may be provided as well as a high gloss surface.

In one embodiment, the wood veneer layer 15 in the embodiment described above with reference to FIGS. 1 and 2 is replaced by a mesh structure (not shown) arranged on the sub-layer comprising an amino resin, as described above with reference to FIGS. 1 and 2. During pressing, material from the sub-layer including the amino resin permeates through the mesh structure such that material from the sub-layer, including the amino resin, is present at the surface of the building panel. The mesh structure may be formed of a metal material. The mesh structure may be an expanded metal. The mesh structure may be formed of a textile material. The textile material may be a non-woven or a woven structure. The textile material may be cloth, fabric, etc. A first and second coating of the above described type is applied as described above with reference to FIGS. 1 and 2 on the surface of the building panel formed by the mesh structure and material such as amino resin from the sub-layer.

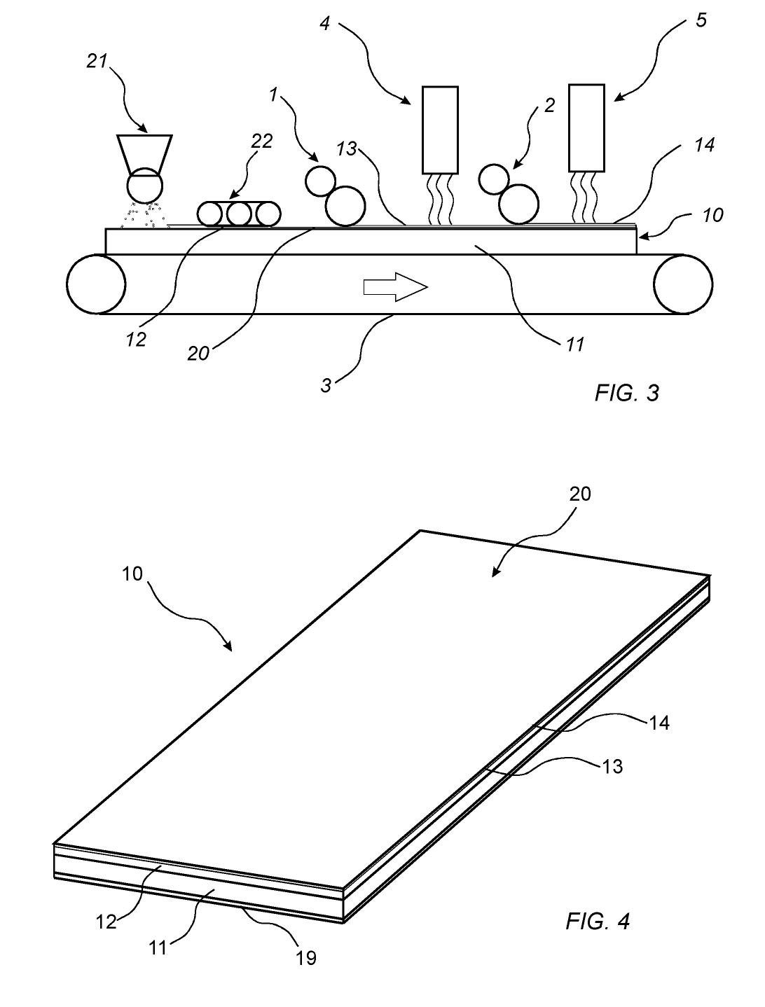

An embodiment of a method of coating a building panel 10 will now be described with reference to FIG. 3. In FIG. 3 a production line including a coating line is shown. The coating line comprises a first coating device 1 and a second coating device 2. In FIG. 3, both the first and the second coating devices 1, 2 are roller coaters, but any other type of coating device is contemplated, such as curtain coating, spraying, dip coating, etc.

A building panel 10 is conveyed by a conveyor 3 through the first coating device 1 and subsequently to the second coating device 2. The building panel 10 comprises a surface layer 12 having a surface 20 to be coated, facing away from the surface facing the conveyor.

The building panel 10 may be a furniture component, a floor panel, a ceiling panel, a wall panel, a door panel, a worktop, skirting boards, mouldings, edging profiles, etc.

The surface 20 of the building panel 10 comprises at least portions including an amino resin. The amino resin may be present in only parts of the surface or in the complete surface. The amino resin may be melamine formaldehyde resin, urea formaldehyde resins, or combinations thereof.

In the embodiment shown in FIG. 3, the surface layer 12 is formed by applying a substantially homogeneous mix comprising at least an amino resin and fillers on a surface of a substrate 11. In the embodiment shown in FIG. 3, the mix is applied by a scattering device 21. The amino resin may be melamine formaldehyde resin, urea formaldehyde resins, or combinations thereof. The fillers may be cellulose fibres. The fillers may be wood fibres and/or wood particles. The mix may further comprise pigments and additives. The mix is preferably applied in dry powder form on the surface of the substrate 11. The substrate 11 may be a board, for example, a wood-based board. The wood-based board may be a wood fibre based board such as MDF, HDF, particleboard, or a plywood board. In other embodiments, the substrate 11 may be a Wood Plastic Composite (WPC). The substrate 11 may be a mineral composite board. The substrate 11 may be a fibre cement board. The substrate 11 may be magnesium oxide cement board. The substrate 11 may be a ceramic board. The substrate 11 may be a plastic board such as a thermoplastic board. In another embodiment, the substrate 11 may be a carrier such as sheet of paper or non-woven, or a conveyor. The substrate 11 may be a thermoplastic foil, such as a polyurethane (PU) or polyvinyl chloride (PVC) foil.

The surface layer may be of the type described in WO2009/065769. The mix may be printed, preferably by an ink jet printer prior to coating. A print in the mix may also be obtained by a binder and print technique (BAP), for example as described in WO 2014/017972.

After the mix has been applied on the substrate, the mix is pressed by applying heat and pressure in a press 22 to form the surface layer 12. The press may be static or be a continuous press.

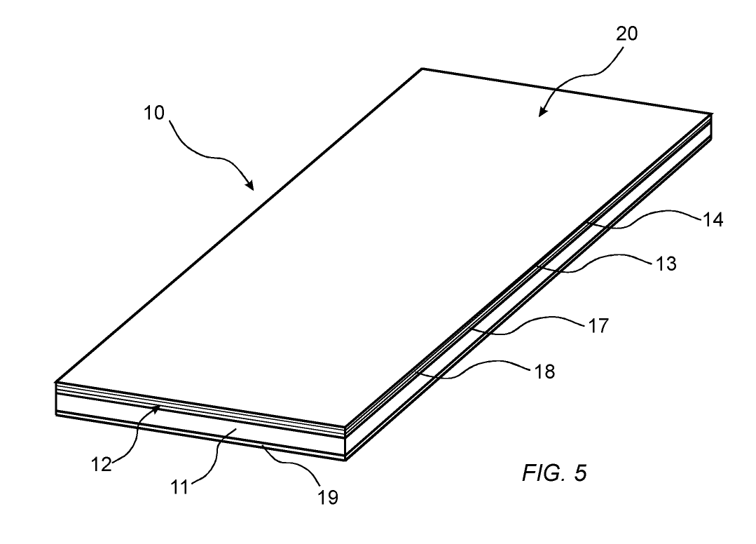

In one embodiment, which will be described in more detail with reference to FIG. 5, the surface layer 12 and the surface 20 thereof comprises at least one sheet, such as a paper sheet, impregnated with an amino resin. The amino resin may be melamine formaldehyde resin, urea formaldehyde resins, or combinations thereof. The surface layer 12 of the building panel 10 may comprise at least a décor paper and an overlay impregnated with an amino resin. The at least one sheet impregnated with the amino resin may be pressed by applying heat and pressure prior to coating.

After pressing, the amino resin is preferably substantially in C-stage prior to coating. By C-stage is meant the thermosetting binder is highly crosslinked and both infusible insoluble. (Principles of Polymerization, George Odian, 3^{rd} edition).

After pressing but prior to applying the first coating composition, the surface 20 of the building panel 10 may be sanded.

As shown in FIG. 3, the building panel 10 is conveyed to the first coating device 1. The first coating device 1 applies a first coating composition on the surface 20 of the building panel 10 including at least portions comprising the amino resin. The first coating composition applied on the surface 20 of the building panel 10 forms a first coating 13. The first coating composition may be applied on at least said portions of the surface 20 of the building panel 10. Preferably, the first coating composition is applied on substantially the complete surface 20 of the building panel.

The first coating composition comprises oligomers having a T_{g}<30° C. Further, the first coating composition comprises reactive portions configured to be reactive with reactive portions of a second coating. The first coating composition is configured to provide adherence to the surface 20 of the building panel 10, and more specifically provide adherence to the portions of the surface 20 of the building panel 10 including amino resins. Due to the low glass transition temperature of the oligomers, the first coating composition is sticky such that the first coating adheres to the surface 20 of the building panel 10. The adherence to the surface 20 of the building panel 10 may be formed by different properties of the first coating 13. For example, the first coating 13 may be physically adhered to portions of the surface 20 of the building panel 10 formed of wood. To portions of the surface 20 of the building panel 10 comprising amino resins, the first coating 13 may be chemically adhered to such portions.

The first coating composition may comprise oligomers with chemical groups that can provide good adherence to surfaces comprising amino resins, especially melamine formaldehyde resin, such as polar hydroxyls, amines, amides and carboxylics that can be found in urethane, epoxy, silane, cyanoacrylate and/or acrylate oligomers. The first coating composition may comprise chemical groups that can be further reacted with a radical chain polymerization such as a UV coating. Such groups can be acrylic, methacrylic, allylic and/or carbon-bonded sulfhydryl groups.

The first coating composition may have a viscosity of less than 10 000 mPas, preferably less than 5000 mPas. For example, the first coating composition may have viscosity in the range of 1000-5000 mPas, preferably in the range of 1000-4000 mPas. Viscosity in such ranges provides desired coating and application properties of the first coating composition.

The first coating composition may be applied in amount of 5-15 g/m². The first coating 13 may be transparent, or at least transparent after drying and/or curing. The first coating 13 may comprise pigments and/or stain, in order to at least partly colour the surface 20 of the building panel 10 if desired.

Prior to applying a second coating composition, the first coating composition is heated to be at least partially cured by applying IR, NIR, hot air, etc., in a first heating device 4 for forming a first coating 13. The first coating 13 is at least partially cured to a state wherein the first coating 13 is no longer tacky. The first coating 13 is at least partially cured to a state there a second coating 14 subsequently applied will not be mixed into the first coating 13. The first coating 13 may also be radiation cured such as by electron beam (EB) and/or UV curing.

The first coating 13 may be a primer for the second coating 14 subsequently applied.

A second coating composition is applied on the first coating 13 for forming a second coating 14. The second coating composition is applied on at least a portion of the first coating 13. Preferably, the second coating composition is applied on substantially the complete first coating 13, such that the second coating 14 covers the first coating 13.

The second coating composition may have a viscosity of less than 10 000 mPas, preferably less than 5000 mPas. For example, the second coating composition may have viscosity in the range of 1000-5000 mPas, preferably in the range of 1000-4000 mPas. Viscosity in such ranges provides desired coating and application properties of the second coating composition.

The second coating composition may be applied in amount of 5-50 g/m². The second coating 14 may be transparent, or at least transparent after drying and/or curing. The second coating 14 may be pigmented and/or stained.

The second coating 14 may form a primer for additional coating layers (not shown), or may form a top coating such as lacquer layer (not shown) having any desired gloss level.

The second coating composition comprises reactive portions configured to react with the reactive portions of the first coating 13. Thereby, a chemical bonding between the first and second coating 13, 14 may be obtained. The reactive portions of the first and second composition may form a covalent bond. The second coating composition may comprise chemical groups that can be further reacted with a radical chain polymerization such as a UV coating. Such groups can typically be acrylic and methacrylic. The second coating composition may comprise photoinitiators. The second coating composition may be radical polymerizable, for example radiation activated. The second coating composition may be radiation curable such as UV curable.

The second coating composition may comprise an acrylate or methacrylate monomer, or an acrylate or methacrylate oligomer. The acrylate or methacrylate monomer or oligomer may be an epoxy (meth)acrylate, a urethane (meth)acrylate, a polyester (meth)acrylate, a polyether (meth)acrylate, an acrylic (meth)acrylate, a silicone (meth)acrylate, a melamine (meth)acrylate, or combinations thereof.

After applying the second coating composition such that the second coating 14 is formed, the second coating 14 may be heated and/or at least partially cured, for example by radiation such as electron beam (EB) and/or UV curing, or by applying heat such as by applying IR, NIR, hot air, etc., in a second heating or radiation device 5.

Subsequent to applying the second coating composition, one or several additional coating compositions may be applied on the second coating for forming additional coatings (not shown). Such additional coatings may be different lacquer layers.

Thereby, a coated building panel 10 is formed.

In FIG. 4, the coated building panel 10, produced by the method described above with reference to FIG. 3, is shown in more detail. The coated building panel 10 may be any type of building panel such as among other a furniture component, a floor panel, a ceiling panel, a wall panel, a door panel, a worktop, skirting boards, mouldings, edging profiles, etc. The coated building panel 10 in FIG. 4 comprises a substrate 11, a surface layer 12 and a balancing layer 19. The substrate 11 may be pre-fabricated, manufactured prior to coating the surface 20 of the building panel 10. The substrate 11 may be a board, for example, a wood-based board. The wood-based board may be a wood fibre based board such as MDF, HDF, particleboard, or a plywood board. In other embodiments, the substrate may be a Wood Plastic Composite (WPC). The substrate 11 may be a mineral composite board. The substrate 11 may be a fibre cement board. The substrate 11 may be magnesium oxide cement board. The substrate 11 may be a ceramic board. The substrate 11 may be a plastic board such as a thermoplastic board. In another embodiment, the substrate 11 may be a carrier such as sheet of paper or non-woven, or a conveyor. The substrate 11 may be a thermoplastic foil, such as a polyurethane (PU) or polyvinyl chloride (PVC) foil.

The balancing layer 19 is arranged on a surface of the substrate 11 opposite to the surface layer 12. The balancing layer 19 may be a powder based balancing layer being applied as a powder. The powder based balancing layer may comprise wood particles such as lignocellulosic and/or cellulosic particles and a binder, preferably a thermosetting binder such as an amino resin. The balancing layer 19 may be a resin impregnated paper, preferably impregnated with a thermosetting binder.

In the embodiment shown in FIG. 4, the surface layer 12, and thereby the surface 20 of the building panel 10 is formed of a substantially homogenous mix comprising an amino resin and filler, such as wood fibres or wood particles. The mix may further comprise pigments, wear resistant particles, additives, etc. The mix is pressed for forming the surface layer 12. The surface layer 12 may be printed, for example, by an inkjet printer.

A first coating 13 of type described above with reference to FIG. 3 is arranged on the surface layer 12. The first coating 13 provides adherence to the surface 20 of the building panel 10. A second coating 14 of the type described above with reference to FIG. 3 is arranged on the first coating 13. The second coating 14 is chemically bonded to the first coating.

The first coating 13 may form a primer for the second coating 14.

In the final product, it may be difficult to see any border between the first coating 13 and the second coating 14. There may be a zone between the first and second coating wherein the first and second coating 13, 14 are fused together.

In one embodiment, the second coating 14 forms a primer for one or several additional coatings (not shown) applied on the second coating 14. Said one or several additional coatings may be different types of lacquer layers, having any desired gloss level. In one embodiment, the second coating forms a top lacquer layer.

The second coating 14 and/or additional coatings applied on the second coating 14 may be lacquers. A lacquered building panel 10 is provided having any desired gloss level. For example, a low gloss surface may be provided as well as a high gloss surface.

A further embodiment of a coated building panel 10 is shown in FIG. 5. The coated building panel 10 may be any type of building panel 10 such as among other a furniture component, a floor panel, a ceiling panel, a wall panel, a door panel, a worktop, skirting boards, mouldings, edging profiles, etc. The coated building panel 10 in FIG. 5 comprises a substrate 11, a surface layer 12 and a balancing layer 19. The substrate 11 may be pre-fabricated, manufactured prior to coating the surface 20 of the building panel 10. The substrate may be a board, for example, a wood-based board. The wood-based board may be a wood fibre based board such as MDF, HDF, particleboard, or a plywood board. In other embodiments, the substrate 11 may be a Wood Plastic Composite (WPC). The substrate 11 may be a mineral composite board. The substrate 11 may be a fibre cement board. The substrate 11 may be magnesium oxide cement board. The substrate 11 may be a ceramic board. The substrate 11 may be a plastic board such as a thermoplastic board. In another embodiment, the substrate 11 may be a carrier such as sheet of paper or non-woven, or a conveyor. The substrate 11 may be a thermoplastic foil, such as a polyurethane (PU) or polyvinyl chloride (PVC) foil.

In the shown embodiment, a balancing layer 19 is arranged on a surface of the substrate 11 opposite to the surface layer 12. The balancing layer 19 may be a powder based balancing layer being applied as a powder. The powder based balancing layer may comprise wood particles such as lignocellulosic and/or cellulosic particles and a binder, preferably a thermosetting binder such as an amino resin. The balancing layer 19 may be a resin impregnated paper, preferably impregnated with a thermosetting binder.

In the embodiment shown in FIG. 5, the surface layer 12, and thereby the surface 20 of the building panel 10 comprises at least one sheet 17, 18 impregnated with an amino resin such as melamine formaldehyde resin, urea formaldehyde resins, or combinations thereof. Said at least one sheet impregnated with the amino resin may be a paper sheet impregnated with an amino resin. In the embodiment shown in FIG. 5, the surface layer 12 comprises an impregnated décor paper 17 and an impregnated overlay paper 18 arranged on the décor paper 17.

Prior to coating, the at least one sheet 17, 18 is pressed to the substrate 11 such that said sheet forms a surface layer 12 of the building panel 10.

In the embodiment shown in FIG. 5, a first coating 13 of type described above with reference to FIG. 3 is arranged on the overlay paper 18 forming the surface 20 of the building panel 10. The first coating 13 provides adherence the overlay paper 18 being impregnated with the amino resin.

A second coating 14 of the type described above with reference to FIG. 3 is arranged on the first coating 13. The second coating 14 is chemically bonded to the first coating 13.

In the final product, it may be difficult to see any border between the first coating and the second coating 13, 14. There may be a zone between the first and second coating 13, 14 wherein the first and second coating 13, 14 are fused together.

In one embodiment, the second coating 14 forms a primer for one or several additional coatings (not shown) applied on the second coating. Said one or several additional coatings may be different types of lacquer layers having any desired gloss level. In one embodiment, the second coating forms a top lacquer layer.

The second coating 14 and/or additional coatings applied on the second coating may be lacquers. A lacquered laminate building panel 10 may be provided having any desired gloss level. For example, a low gloss surface may be provided as well as a high gloss surface.

In the above description, the second coating 14 is described as applied in one layer. However, it is contemplated the first and/or second coating composition may be applied in several steps, such that the first and second coating comprises several layers of the first and the second coating composition, respectively.

It is contemplated that there are numerous modifications of the embodiments described herein, which are still within the scope of the invention as defined by the appended claims.

### EXAMPLES

### Comparative Example

A building panel is provided, comprising a HDF substrate, a sub-layer comprising wood fibres and melamine formaldehyde resin arranged on the substrate, and a wood veneer layer arranged on the sub-layer. The components of the building panel have been pressed, and during pressing material from the sub-layer such as melamine resin has permeated through the wood veneer layer, for example, through holes, cracks and/or pores of the wood veneer layer.

After pressing, the surface of the building panel, formed by the wood veneer layer and material from the sub-layer, is sanded. A primer (UC/61099-470, Sherwin-Williams) was applied in an amount of 10 g/m2. The primer was gelled with UV radiation. A UV curable base coat (UL1124, Sherwin-Williams) was applied on the second coating in an amount of 11 g/m2 and thereafter UV cured. The base coat was sanded after curing. After sanding the base coat, a first wear resistant coating (UL1117, Sherwin-Williams) was applied on the base coat in an amount of 30 g/m2 and thereafter gelled. A second wear resistant coating (UL1117, Sherwin-Williams) was applied on the first wear resistant coating in an amount of 15 g/m2 and thereafter gelled. Thereafter, a UV curable top coat (UM1112-0030, Sherwin-Williams) was applied on the second wear resistant coating in an amount of 9.5 g/m2 and UV cured.

In a pull off test in accordance with ISO 4624:2016 was performed on the building panel in order to evaluate adhesion of the coatings. Adherence of the coatings to the surface was 2.6-2.9 MPa, A/B 90%, -/Y 10% as measured in accordance with ISO 4624:2016.

In a Hamberger Hobel test, the adherence of the coatings to the surface was measured to 16 N.

### Example 1

A building panel is provided, comprising a HDF substrate, a sub-layer comprising wood fibres and melamine formaldehyde resin arranged on the substrate, and a wood veneer layer arranged on the sub-layer. The components of the building panel have been pressed, and during pressing material from the sub-layer including the melamine resin has permeated through the wood veneer layer, for example, through holes, cracks and/or pores of the wood veneer layer.

After pressing, the surface of the building panel, formed by the wood veneer layer and material from the sub-layer, is sanded. A first coating composition in form of an adhesion primer (16073-4h, Mercene Labs) was applied on the sanded surface of the building panel in an amount of 8.5 g/m2. The first coating was heat cured to 130° C. A second coating composition in form of a primer (UC/61099-470, Sherwin-Williams) was applied in an amount of 10 g/m2. The second coating was gelled with UV radiation. A UV curable base coat (UL1124, Sherwin-Williams) was applied on the second coating in an amount of 11 g/m2 and thereafter UV cured. The base coat was sanded after curing. After sanding the base coat, a first wear resistant coating (UL1117, Sherwin-Williams) was applied on the base coat in an amount of 30 g/m2 and thereafter gelled. A second wear resistant coating (UL1117, Sherwin-Williams) was applied on the first wear resistant coating in an amount of 15 g/m2 and thereafter gelled. Thereafter, a UV curable top coat (UM1112-0030, Sherwin-Williams) was applied on the second wear resistant coating in an amount of 9.5 g/m2 and UV cured.

In a pull off test in accordance with ISO 4624:2016 was performed on the building panel in order to evaluate adhesion of the coatings. Adherence of the coatings to the surface was 4 MPa, A 50%, A/B 50% as measured in accordance with ISO 4624:2016.

In a Hamberger Hobel test, the adherence of the coatings to the surface was measured to 22 N.

### Example 2

A building panel is provided, comprising a HDF substrate and a surface layer formed by a mix comprising wood fibres, melamine formaldehyde resin and wear resistant particles, wherein heat and pressure have been applied to the mix to form the surface layer. The surface layer was printed with a décor.

After pressing, a first coating composition in form of an adhesion primer (16073-4h, Mercene Labs) was applied on the surface of the building panel in an amount of 10 g/m2. The first coating was UV cured. A base coat (UU75069, Hesse) was applied on the primer in two layers, applied wet in wet, in an amount of 10+50 g/m2, heated to 50° C. and thereafter UV cured. The base coat was sanded after curing. After sanding the base coat, the base coat and the first coating composition were heated to 120° C. and a top coat (UU75069, Hesse) was thereafter applied on the base coat in two layers, applied wet in wet, in an amount of 10+50 g/m2, heated to 50° C. and thereafter UV cured.

In a pull off test in accordance with ISO 4624:2016 was performed on the building panel in order to evaluate adhesion of the coatings. Adherence of the coatings to the substrate was 4.2 MPa, A 80%, A/B 15%, -/Y 5% as measured in accordance with ISO 4624:2016.

In a Hamberger Hobel test, the adherence of the coatings to the substrate was measured to 32 N.

### Example 3

A building panel is provided comprising a HDF substrate and a surface layer formed by a melamine resin impregnated décor paper and a melamine resin impregnated overlay, wherein heat and pressure have been applied to the décor paper and overlay to form the surface layer.

After pressing, a first coating composition in form of an adhesion primer (16073-4h, Mercene Labs) was applied on the surface of the building panel in an amount of 10 g/m2. The first coating was UV cured. A base coat (UU75069, Hesse) was applied on the primer in two layers, applied wet in wet, in an amount of 10+50 g/m2, heated to 50° C. and thereafter UV cured. The base coat was sanded after curing. After sanding the base coat, the base coat and the first coating composition were heated to 120° C. and a top coat (UU75069, Hesse) was thereafter applied on the base coat in two layers, applied wet in wet, in an amount of 10+50 g/m2, heated to 50° C. and thereafter UV cured.

### Example 4

A building panel is provided, comprising a HDF substrate, a sub-layer comprising wood fibres and melamine formaldehyde resin arranged on the substrate, and a wood veneer layer arranged on the sub-layer. The components of the building panel have been pressed, and during pressing material from the sub-layer including the melamine resin has permeated through the wood veneer layer, for example, through holes, cracks and/or pores of the wood veneer layer.

After pressing, the surface of the building panel, formed by the wood veneer layer and material from the sub-layer, is sanded. A first coating composition in form of an adhesion primer (Duoprime M, Mercene Labs) was applied on the sanded surface of the building panel in an amount of 10 g/m2. The first coating was heat cured for 16 s to 85-90° C. A second coating composition in form of a primer (UC/61099-470, Sherwin-Williams) was applied in an amount of 8 g/m2. The second coating was gelled with UV radiation. A UV curable base coat (UL1124, Sherwin-Williams) was applied on the second coating in an amount of 13 g/m2 and thereafter UV cured. The base coat was sanded after curing. After sanding the base coat, a first wear resistant coating (UL1117, Sherwin-Williams) was applied on the base coat in an amount of 19 g/m2 and thereafter gelled. A second wear resistant coating (UL1117, Sherwin-Williams) was applied on the first wear resistant coating in an amount of 19 g/m2 and thereafter gelled. Thereafter, a UV curable top coat (UM1111-0104, Sherwin-Williams) was applied on the second wear resistant coating in an amount of 7 g/m2 and thereafter gelled. A second UV curable top coat (UM1111-0104, Sherwin-Williams) was applied on the first UV curable top coat in an amount of 7 g/m2 and thereafter UV cured.

In a pull off test in accordance with ISO 4624:2016 was performed on the building panel in order to evaluate adhesion of the coatings. Adherence of the coatings to the surface was 3.3 MPa, as measured in accordance with ISO 4624:2016.

In a Hamberger Hobel test, the adherence of the coatings to the surface was measured to 26 N.

### Example 5

A building panel is provided, comprising a HDF substrate and a surface layer formed by a mix comprising wood fibres, melamine formaldehyde resin and wear resistant particles, wherein heat and pressure have been applied to the mix to form the surface layer. The surface layer was printed with a décor.

A first coating composition in form of an adhesion primer (Duoprime M, Mercene Labs) was applied on the surface of the building panel in an amount of 10 g/m2. The first coating was heat cured for 16 s to 85-90° C. A second coating composition in form of a primer (UC/61099-470, Sherwin-Williams) was applied in an amount of 8 g/m2. The second coating was gelled with UV radiation. A UV curable base coat (UL1124, Sherwin-Williams) was applied on the second coating in an amount of 13 g/m2 and thereafter UV cured. The base coat was sanded after curing. After sanding the base coat, a first wear resistant coating (UL1117, Sherwin-Williams) was applied on the base coat in an amount of 19 g/m2 and thereafter gelled. A second wear resistant coating (UL1117, Sherwin-Williams) was applied on the first wear resistant coating in an amount of 19 g/m2 and thereafter gelled. Thereafter, a UV curable top coat (UM1111-0104, Sherwin-Williams) was applied on the second wear resistant coating in an amount of 7 g/m2 and thereafter gelled. A second UV curable top coat (UM1111-0104, Sherwin-Williams) was applied on the first UV curable top coat in an amount of 7 g/m2 and thereafter UV cured.

1. A method to at least partially coat a building panel, the method comprising
applying a sub-layer comprising an amino resin on a substrate,
applying a wood veneer layer on the sub-layer,
pressing the wood veneer layer and the sub-layer such that the amino resin from the sub-layer permeates through the wood veneer layer and after pressing is present at at least portions of a surface of the wood veneer layer facing away from the substrate,
subsequently applying a first coating composition on the surface of the wood veneer layer comprising said portions including the amino resin, for forming a first coating on at least said portions of said surface, wherein the first coating composition comprises oligomers having a glass transition temperature less than 30° C. and reactive portions,
heat curing the first coating composition such that the first coating composition is at least partially cured and a first coating is formed, and
subsequently applying a second coating composition on at least portions of the at least partially cured first coating for forming a second coating, wherein the second coating composition comprises reactive portions configured to react with the reactive portions of the first coating composition.

2. The method according to claim 1, wherein the oligomers having chemical groups comprising polar hydroxyls, amines, amides and carboxylics, epoxy, silane, cyanoacrylate and/or acrylate oligomers.

3. The method according to claim 1, wherein the reactive portions of the first and second coating composition form a covalent bond.

4. The method according to claim 1, wherein the first coating composition has a viscosity less than 10 000 mPas.

5. The method according to claim 1, wherein the first coating composition has viscosity in the range of 1000-5000 mPas.

6. The method according to claim 1, wherein the second coating composition is radiation curable.

7. The method according to claim 1, wherein the reactive portions of the second coating composition are radical polymerizable.

8. The method according to claim 1, wherein the first coating and/or the second coating is transparent.

9. The method according to claim 1, wherein the first and/or second coating composition comprising pigments and/or stains.

10. The method according to claim 1, further comprising applying one or several further coating compositions on the second coating.

11. A coated building panel comprising
a substrate, a sub-layer arranged on the substrate, and a wood veneer layer, wherein the wood veneer layer has a surface facing away from the substrate comprising at least portions including an amino resin,
a first coating adhered to at least said portions of said surface including the amino resin,
a second coating chemically bonded to the first coating, and
optionally one or several further coatings arranged on the second coating,
wherein adherence between said surface and the first and second coating is exceeding 3 MPa, as measured in accordance with ISO 4624:2016.

12. The coated building panel according to claim 11, wherein the first coating comprising chemical groups comprising polar hydroxyls, amines, amides and carboxylics, epoxy, silane, cyanoacrylate and/or acrylate oligomers.

13. The coated building panel according to claim 11, wherein the second coating is bonded to the first coating by radical polymerization.

14. The coated building panel according to claim 11, wherein oligomers of the first coating has a glass transition temperature exceeding 30° C.

15. The coated building panel according to claim 11, wherein the second coating comprises acrylate or methacrylate polymer.

16. The coated building panel according to claim 15, wherein the second coating is radiation cured.

17. A method to at least partially coat a building panel, the method comprising
applying a substantially homogenous mix comprising an amino resin and fillers on a substrate,
pressing the mix to a surface layer comprising the amino resin and the fillers,
subsequently applying a first coating composition on a surface of the surface layer facing away from the substrate for forming a first coating on said surface, wherein the first coating composition comprises oligomers having a glass transition temperature less than 30° C. and reactive portions,
heat curing the first coating composition such that the first coating composition is at least partially cured and a first coating is formed, and
subsequently applying a second coating composition on at least portions of the at least partially cured first coating for forming a second coating, wherein the second coating composition comprises reactive portions configured to react with the reactive portions of the first coating composition.

18. A coated building panel, comprising
a substrate and a surface layer comprising an amino resin and filler,
a first coating adhered to a surface of the surface layer facing away from the substrate,
a second coating chemically bonded to the first coating, and
optionally one or several further coatings arranged on the second coating,
wherein adherence between said surface and the first and second coating is exceeding 3 MPa, preferably exceeding 3.2 MPa, as measured in accordance with ISO 4624:2016.
